(19) United States
(12) Patent Application Publication
(10) Pub. No.: US 2016/0131041 A1
(43) Pub. Date: May 12, 2016

(54) TURBOMACHINE INCLUDING A TRANISTION PIECE TO TURBINE PORTION VARIABLE PURGE FLOW SEAL MEMBER

(71) Applicant: General Electric Company, Schenectady, NY (US)

(72) Inventors: Stephen Paul Wassynger, Simpsonville, SC (US); Joe Timothy Brown, Simpsonville, SC (US); Sivaraman Vedhagiri, Greer, SC (US)

(21) Appl. No.: 14/534,934

(22) Filed: Nov. 6, 2014

(51) Int. Cl. F02C 7/20; F02C 5/02; F02C 3/04

(52) U.S. Cl. CPC F02C 7/20; F02C 3/04; F02C 5/02

(57) ABSTRACT

A turbomachine includes a compressor portion, and a turbine portion operatively connected to the compressor portion. The turbine portion includes a compressor discharge portion, a hot gas path and a first stage nozzle arranged at the hot gas path. A combustor assembly is fluidically connected to the compressor portion. A transition piece has an inlet portion fluidically connected to the combustor assembly and an outlet portion fluidically connected to the turbine portion. A seal member is operatively connected relative to one of the transition piece and the first stage nozzle of the turbine portion. The seal member extends from a first end to a second, cantilevered end through an intermediate portion including one or more openings that provide a purge fluid flow path from the compressor discharge portion toward the hot gas path.

### BACKGROUND OF THE INVENTION

The subject matter disclosed herein relates to the art of turbomachine systems and, more particularly to a variable purge flow seal employed between a transition piece and a turbine portion of a turbomachine system.

Turbomachine systems typically include a turbomachine coupled to an intake system and a load. The turbomachine typically includes a compressor portion and a turbine portion. An airstream passes through the intake system into the compressor portion. The compressor portion forms a compressed air stream that is introduced into the turbine portion. In a gas turbomachine, a portion of the compressed airstream mixes with products of combustion in a combustor assembly forming a hot gas stream that is introduced into the turbine portion through a transition piece.

The hot gas stream flows from a transition piece fluidically connecting the combustor assembly and the turbine portion. The hot gases passing from the transition piece flow toward a first stage of the turbine portion. The hot gases flow over a first stage nozzle prior to impacting first stage rotor blades. The first stage nozzle conditions and directs the hot gases toward the first stage rotor blades. The hot gases expand through additional stages of the turbine portion each having associated rotor blades before passing to an exhaust system. The rotor blades are generally connected to a wheel which, in turn, may be connected to a shaft. Typically, the shaft is operatively connected to a load. The hot gas stream imparts a force to the rotor blades causing rotation of the shaft. The rotation of the shaft is transferred to the rotor. Thus, the turbine portion converts thermal energy from the hot gas stream into mechanical/rotational energy that is used to drive the load. The load may take on a variety of forms including a generator, a pump, an aircraft, a locomotive, or the like.

### BRIEF DESCRIPTION OF THE INVENTION

According to one aspect of an exemplary embodiment, a turbomachine includes a compressor portion, and a turbine portion operatively connected to the compressor portion. The turbine portion includes a compressor discharge portion, a hot gas path, and a first stage nozzle arranged at the hot gas path. A combustor assembly is fluidically connected to the compressor portion. A transition piece has an inlet portion fluidically connected to the combustor assembly and an outlet portion fluidically connected to the turbine portion. A seal member is operatively connected relative to one of the transition piece and the first stage nozzle of the turbine portion. The seal member extends from a first end to a second, cantilevered end through an intermediate portion including one or more openings that provide a variable purge fluid flow from the compressor discharge portion toward the hot gas path.

According to another aspect of an exemplary embodiment, a turbomachine system includes a compressor portion including an inlet, an intake system fluidically connected to the inlet of the compressor portion, and a turbine portion operatively connected to the compressor portion. The turbine portion includes a compressor discharge portion, a hot gas path and a first stage nozzle arranged at the hot gas path. A load is operatively connected to one of the compressor portion and the turbine portion. A combustor assembly is fluidically connected to the compressor portion. A transition piece has an inlet portion fluidically connected to the combustor assembly and an outlet portion fluidically connected to the turbine portion. A seal member is operatively connected relative to one of the transition piece and the first stage nozzle of the turbine portion. The seal member extends from a first end to a second, cantilevered end through an intermediate portion including one or more openings that provide a variable purge fluid flow from the compressor discharge portion toward the hot gas path.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 depicts a schematic view of a turbomachine system including a turbomachine having seal member, in accordance with an exemplary embodiment;

FIG. 2 depicts a partial cross-sectional view of the turbomachine of FIG. 1;

FIG. 3 depicts a partial cross-sectional view of a first stage of a turbine portion of the turbomachine system of FIG. 1;

FIG. 4 depicts a perspective view of the seal member of FIG. 1; and

FIG. 5 depicts a perspective view of a seal member, in accordance with another aspect of an exemplary embodiment.

The detailed description explains embodiments of the invention, together with advantages and features, by way of example with reference to the drawings.

### DETAILED DESCRIPTION OF THE INVENTION

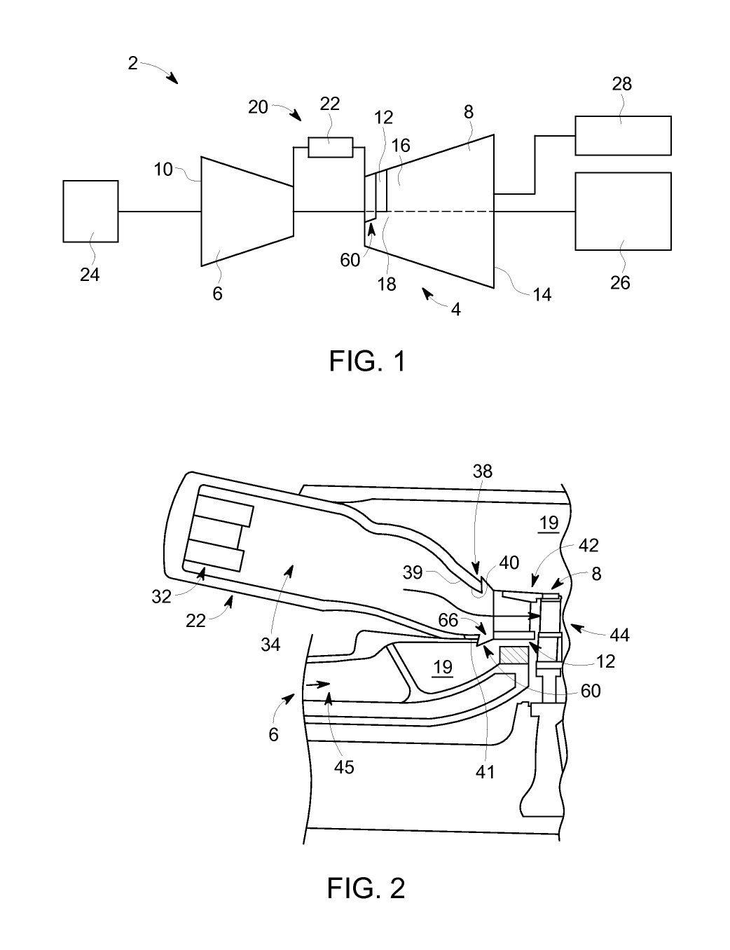

With initial reference to FIGS. 1 and 2, a turbomachine system is indicated generally at 2. Turbomachine system 2 includes a turbomachine 4 having a compressor portion 6 connected to a turbine portion 8. Compressor portion 6 includes an inlet 10. Turbine portion 8 includes a first stage nozzle 12 arranged at an inlet (not separately labeled). Turbine portion 8 also includes an outlet 14. First stage nozzle 12 conditions combustion gases flowing along a hot gas path 16. Hot gas path 16 is arranged radially outwardly of a wheel space portion 18 and a compressor discharge plenum or portion 19. The combustion gases are generated in a combustor assembly 20 fluidically connecting compressor portion 6 and turbine portion 8. Combustor assembly 20 includes one or more combustors 22. Turbomachine system 2 is further shown to include an intake system 24 fluidically connected to inlet 10 and a load 26 that may be operatively connected to turbine portion 8. It should be understood that load 26 may also be connected to compressor portion 6. An exhaust system 28 is fluidically connected to outlet 14 of turbine portion 8. Exhaust system 28 receives and conditions exhaust gases passing from turbomachine 4.

As shown in FIG. 2, combustor 22 includes a plurality of nozzles 32 that deliver a combustible mixture into a combustion chamber 34. The combustible mixture is combusted forming products of combustion that pass from combustor 22 into turbine portion 8 via a transition piece 38. Transition piece 38 extends from an inlet portion 39, fluidically connected to combustor 22, to an outlet portion 40 coupled to an aft frame 41. The products of combustion flow along hot gas path 16 interacting with turbine blades, such as shown at 44, creating work that powers load 26. In addition to the products of combustion, compressed air passes from compressor portion 6 to wheel space portion 18 via a diffuser 45 fluidically connected to compressor discharge portion 19. The compressed air provides cooling and purge flows in turbine portion 8.

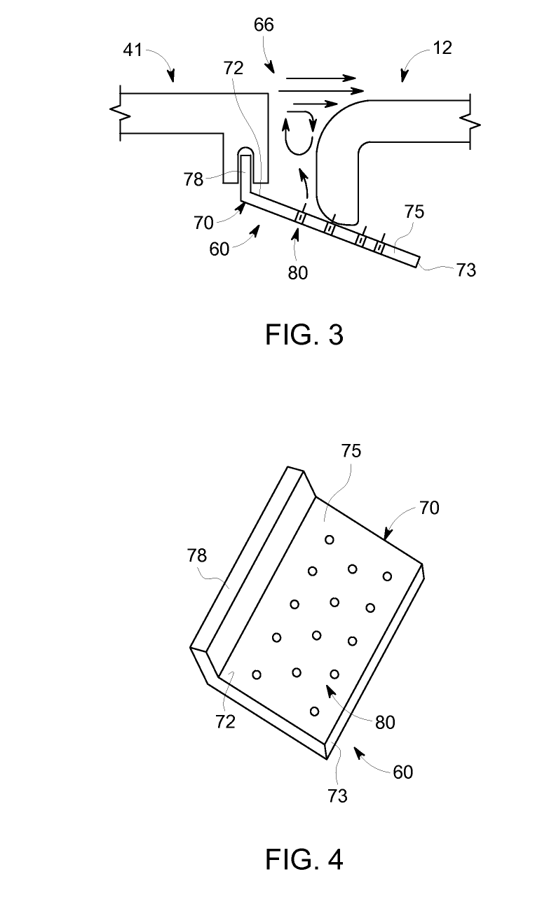

In accordance with an exemplary embodiment, turbomachine 4 includes a seal member 60 that extends between aft frame 41 and first stage nozzle 12. As will be discussed more fully below, seal member 60 prevents hot gases from entering compressor discharge portion 19 via a trench cavity 66. As shown in FIGS. 3 and 4, seal member 60 includes a body 70 that extends from a first end 72 to a second, cantilevered end 73 through an intermediate portion 75. A mounting member 78 is provided at first end 72 and serves as an interface between seal member 60 and aft frame 41. Of course, it should be understood that seal member 60 may alternatively be fixedly mounted to first stage nozzle 12 and extend toward aft frame 41. Intermediate portion 75 is pre-loaded, or biased, toward first stage nozzle 12. In this manner, seal member 60 remains in contact with first stage nozzle 12 during operation of turbine portion 8.

In further accordance with an exemplary embodiment, seal member 60 includes one or more openings, indicated generally at 80, that extend through intermediate portion 75. Openings 80 are generally circular and extend between first end 72 and second end 73. Openings 80 allow compressed air to pass from compressor discharge portion 19 toward hot gas path 16. The compressed air interacts with the products of combustion creating a flow vortex in trench cavity 66. The flow vortex improves an overall sealing efficacy of seal member 60.

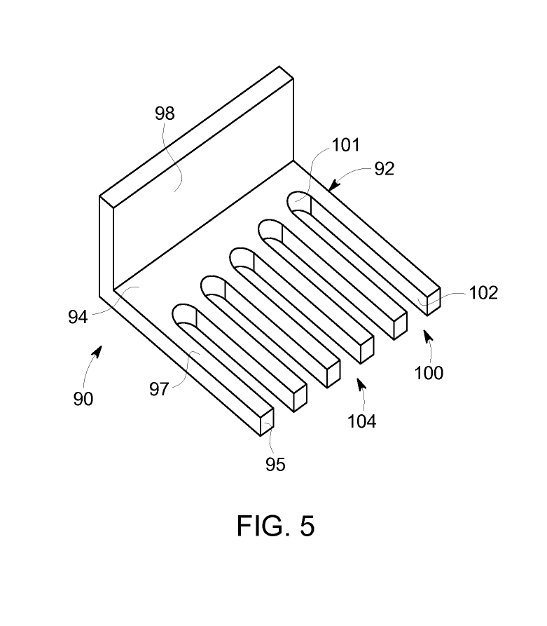

In accordance with another aspect of the exemplary embodiment illustrated in FIG. 5, a seal member 90 includes a body 92 that extends from a first end 94 to a second, cantilevered end 95 through an intermediate portion 97. A mounting member 98 is provided at first end 94 and serves as an interface between seal member 90 and aft frame 41. Of course, it should be understood that seal member 90 may alternatively be fixedly mounted to first stage nozzle 12 and extend toward aft frame 41. Intermediate portion 97 is pre-loaded, or biased, toward first stage nozzle 12. In this manner, seal member 90 remains in contact with first stage nozzle 12 during operation of turbine portion 8.

In further accordance with the another aspect of the exemplary embodiment, seal member 90 includes one or more openings, indicated generally at 100, that extend through intermediate portion 97. Openings 100 take the form of elongated opening that extend from a first end section 101 arranged at first end 94 toward a second end section 102 arranged at second end 95. Openings 100 allow a variable purge fluid flow in the form of compressed air to pass from compressor discharge portion 19 toward hot gas path 16. The compressed air interacts with the products of combustion creating a flow vortex in trench cavity 66. The flow vortex improves an overall sealing efficacy of seal member 90. In the exemplary aspect shown, second end section 102 extends through second end 95. In this manner, openings 100 may create a plurality of voids 104 in second end 95.

At this point it should be understood that the exemplary embodiments describe a seal member that spans a trench cavity in a turbine portion of a turbomachine. The seal member maintains a seal as components of the turbine portion expand/grow during operation. The seal includes openings that allow compressed air to pass from the compressor discharge portion to the hot gas path to reduce hot gas injection through the trench cavity. Further, by adjusting the number, size, shape, pattern and/or location of the openings, the flow through the seal member may be regulated for various turbomachine installations and operating conditions. In addition, it should be understood that the seal may be arranged in an inner diameter of the nozzle, an outer diameter of the nozzle, or may extend annularly about the nozzles.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A turbomachine comprising:
a compressor portion;
a turbine portion operatively connected to the compressor portion, the turbine portion including a compressor discharge portion, a hot gas path and a first stage nozzle arranged at the hot gas path;
a combustor assembly fluidically connected to the compressor portion;
a transition piece having an inlet portion fluidically connected to the combustor assembly and an outlet portion fluidically connected to the turbine portion; and
a seal member operatively connected relative to one of the transition piece and the first stage nozzle of the turbine portion, the seal member extending from a first end to a second, cantilevered end through an intermediate portion including one or more openings that provide a purge fluid flow path from the compressor discharge portion toward the hot gas path.

2. The turbomachine according to claim 1, wherein the one or more openings include a plurality of openings that extend across the intermediate portion.

3. The turbomachine according to claim 2, wherein the plurality of openings comprise a plurality of circular openings.

4. The turbomachine according to claim 2, wherein the plurality of openings comprise a plurality of elongated openings.

5. The turbomachine according to claim 4, wherein the plurality of openings extend from a first end section arranged at the first end to a second end section arranged at the second, cantilevered end.

6. The turbomachine according to claim 5, wherein the plurality of openings extends through the second end.

7. The turbomachine according to claim 1, wherein the seal member is operatively connected relative to the transition piece.

8. The turbomachine according to claim 7, wherein the transition piece includes an aft frame, the seal member being operatively connected to the aft frame.

9. The turbomachine according to claim 1, wherein the seal member includes a mounting member arranged at the first end.

10. The turbomachine according to claim 1, wherein the second end of the seal member is biased toward the other of the transition piece and the first stage nozzle of the turbine portion.

11. A turbomachine system comprising:
a compressor portion including an inlet;
an intake system fluidically connected to the inlet of the compressor portion;
a turbine portion operatively connected to the compressor portion, the turbine portion including a compressor discharge portion, a hot gas path and a first stage nozzle arranged at the hot gas path;
a load operatively connected to one of the compressor portion and the turbine portion;
a combustor assembly fluidically connected to the compressor portion;
a transition piece having an inlet portion fluidically connected to the combustor assembly and an outlet portion fluidically connected to the turbine portion; and
a seal member operatively connected relative to one of the transition piece and the first stage nozzle of the turbine portion, the seal member extending from a first end to a second, cantilevered end through an intermediate portion including one or more openings that provide a purge fluid flow path from the compressor discharge portion toward the hot gas path.

12. The turbomachine system according to claim 11, wherein the one or more openings include a plurality of openings that extend across the intermediate portion.

13. The turbomachine system according to claim 12, wherein the plurality of openings comprise a plurality of circular openings.

14. The turbomachine system according to claim 12, wherein the plurality of openings comprise a plurality of elongated openings.

15. The turbomachine system according to claim 14, wherein the plurality of openings extend from a first end section arranged at the first end to a second end section arranged at the second end.

16. The turbomachine system according to claim 15, wherein the plurality of openings extends through the second end.

17. The turbomachine system according to claim 11, wherein the seal member is operatively connected relative to the transition piece.

18. The turbomachine system according to claim 17, wherein the transition piece includes an aft frame, the seal member being operatively connected to the aft frame.

19. The turbomachine system according to claim 11, wherein the seal member includes a mounting member arranged at the first end.

20. The turbomachine system according to claim 11, wherein the second end of the seal member is biased toward the other of the transition piece and the first stage nozzle of the turbine portion.
